(19) United States
(12) Patent Application Publication
(10) Pub. No.: US 2005/0207292 A1
(43) Pub. Date: Sep. 22, 2005

(54) METHOD AND APPARATUS FOR RECORDING DATA ON OPTICAL DISKS

(76) Inventor: Min-I HUNG, Taipei City (TW)

Correspondence Address: NORTH AMERICA INTERNATIONAL PATENT OFFICE (NAIPC), P.O. BOX 506, MERRIFIELD, VA, 22116, US

(21) Appl. No.: 10/906,656

(22) Filed: Mar. 1, 2005

(30) Foreign Application Priority Data
Mar. 19, 2004 (TW) 093107458

(51) Int. Cl. G11B 5/09

(52) U.S. Cl. 369/47.5

(57) ABSTRACT

A method for recording data on an unformatted optical disk, wherein the optical disk has a lead-in zone and a data zone, includes: writing a storage data into the data zone according to a predetermined laser power before the lead-in zone records data; and beginning to write disk information into the lead-in zone when the storage data is completely recorded in the data zone.

### BACKGROUND OF INVENTION

1. Field of the Invention

The present invention relates to a method and apparatus for recording data on an optical disk, and more particularly, to a method and apparatus for recording data on an unformatted DVD.

2. Description of the Prior Art

With the advancement of optical storage techniques, digital versatile disks (DVD) are widely used for storing data. For example, a re-writable DVD (such as DVD+RW disk) is usually employed as a storage medium in a digital video recorder.

A DVD+RW disk comprises a lead-in zone for recording disk identification information and a data zone for storing data. In the prior art, the lead-in zone of an unformatted DVD+RW disk should be formatted first before writing data into the data zone of the DVD+RW disk.

FIG. 1 depicts a flowchart of how an optical disk drive records data on an unformatted DVD+RW disk according to the prior art. The steps of the flowchart are described as follows.

First, the conventional optical disk drive executes step 104 before writing data. The conventional optical disk drive performs an optimum power control (OPC) procedure to obtain an optimum laser power for its pick-up head.

Since the optical disk is unformatted, the optical disk drive next executes step 106 to format the lead-in zone of the optical disk. According to the specification of DVD+RW format, the lead-in zone of the optical disk comprises many sections, such as inner disk test zone, reserved zone, inner disk identification zone, buffer zone, control data zone, and other sections. The inner disk identification zone further comprises formatting disk control blocks (FDCB) for recording the formatting status and mode of the optical disk, last written address, and formatting bitmap. In step 106, the conventional optical disk drive formats the lead-in zone of the optical disk by writing corresponding initial values to each section of the lead-in zone.

Next, the conventional optical disk drive executes step 108 to utilize the pick-up head to write data into the data zone of the optical disk.

After data needing to be written are completely recorded into the data zone of the DVD+RW disk, the optical disk drive executes step 110 when it receives a close track/session instruction. The optical disk drive updates the initial values recorded in the FDCB of the lead-in zone with the last written address of the data zone to represent the actual quantity of recorded data in the optical disk. In step 110, the optical disk drive creates a real lead-out zone or a temporary lead-out zone to complete the recording procedure. If the optical disk drive has not received the close track/session instruction yet, it can continuously perform a background format procedure.

In other words, the conventional optical disk drive should complete the OPC procedure and write required initial values into the lead-in zone of the optical disk before writing data into the data zone of the unformatted DVD+RW disk. As a result, there is an obvious time gap between the time that a user orders the optical disk drive to record data and the time that the optical disk drive begins to record data.

If a user operates the conventional optical disk drive to record a video program which he/she wants to record when he/she watches it, as mentioned above, the DVD disk recording method of the prior art is unable to respond quickly enough to the user's instruction, so that parts of the video program that needs to be recorded are missed.

### SUMMARY OF INVENTION

It is therefore an objective of the claimed invention to provide a method and apparatus for recording data on an optical disk to solve the above-mentioned problem by changing the writing procedure.

According to a preferred embodiment of the present invention, a method for recording data on an unformatted optical disk which has a lead-in zone and a data zone includes: writing a storage data into the data zone according to a predetermined laser power before the lead-in zone records data; and beginning to write disk information into the lead-in zone when the storage data is completely recorded in the data zone.

Another objective of the present invention is to provide a method for recording data into an optical disk which has a lead-in zone and a data zone. The method includes: (a) writing a storage data into the data zone according to a predetermined laser power; (b) recording a last written address of the data zone for each predetermined period; and (c) if the storage data not is not completely recorded in the data zone when step (a) is stopped, selecting one of the recorded last written addresses to write into the lead-in zone.

According to a preferred embodiment, an optical storage device for recording a storage data into an optical disk, which has a lead-in zone and a data zone, is disclosed. The optical storage device includes: a pick-up head writing the storage data into the optical disk; and a control circuit electrically connected to the pick-up head for controlling the pick-up head to write the storage data into the data zone according to a predetermined laser power before the lead-in zone is recorded with data and for controlling the pick-up head to begin to write disk information into the lead-in zone when the storage data has been completely recorded in the data zone.

One advantage of the present invention is that it directly records data into the data zone without formatting the lead-in zone first, so that the lead time is greatly reduced.

Another advantage of the present invention is that the last written address of the data zone can be recorded for each predetermined period, so that even when power is interrupted or another abnormal situation occurs while writing data, the optical disk can be recovered according to the last written address recorded in the memory.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a flowchart of recording data into an unformatted DVD+RW disk according to the prior art.

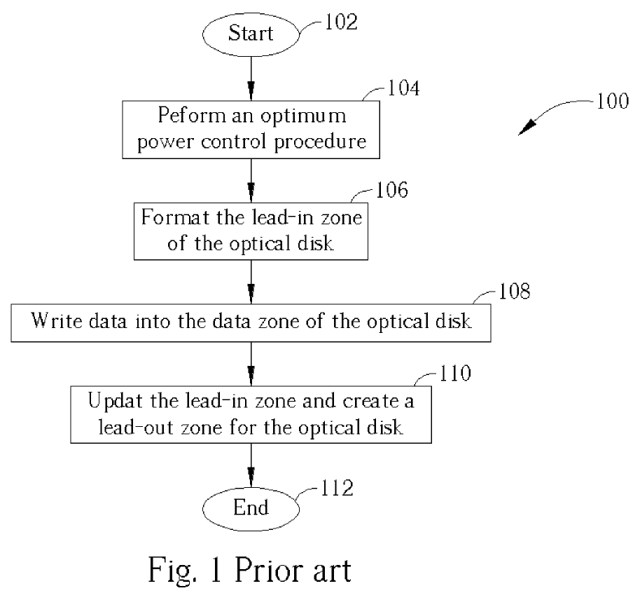

FIG. 2 is a schematic diagram of an optical disk drive according to the present invention.

FIG. 3 is a flowchart of recording data into an unformatted DVD+RW disk according to the present invention.

### DETAILED DESCRIPTION

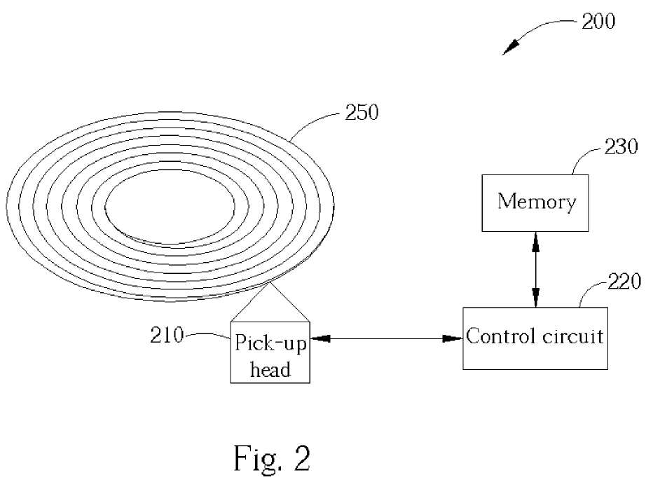

Please refer to FIG. 2, which depicts a schematic diagram of an optical disk drive 200 according to the present invention. The optical disk drive 200 comprises a pick-up head 210 for writing a storage data into an optical disk 250; a control circuit 220 electrically connected to the pick-up head 210 for controlling the operation of the pick-up head 210; and a memory 230 electrically connected to the control circuit 220 for recording the last written address of the optical disk 250 for each predetermined period. In practical applications, the optical disk drive 200 of the present invention can be a DVD video recorder, a DVD optical disk drive used in a computer system or a like. In a preferred embodiment, the memory 230 can be a non-volatile memory such as an EEPROM or a FLASH etc.

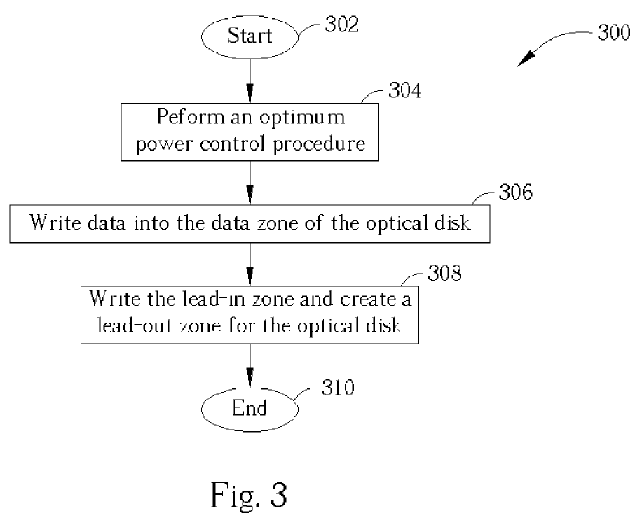

FIG. 3 depicts a flowchart of the optical disk drive 200 records data on the optical disk 250 according to the present invention. The flowchart comprises following steps:

Step 302: Start.

Step 304: Performing an optimum power control (OPC) procedure.

Step 306: Writing data into the data zone of the optical disk 250.

Step 308: Writing the lead-in zone of the optical disk 250 and creating the lead-out zone of the optical disk 250.

Step 310: End.

In following embodiment, the optical disk 250 is assumed to be an unformatted DVD+RW disk to conveniently illustrate the operation of the optical disk drive 200 of the present invention.

In general, in order to improve the correctness of recorded data, the control circuit 220 of the optical disk drive 200 executes step 304 to control the pick-up head 210 to perform an OPC procedure to decide a predetermined laser power for use in recording data when the control circuit 220 receives a recording instruction.

Next, in step 306, the optical disk drive 200 immediately writes a received data (such as a video program) into the data zone of the optical disk 250 without formatting the lead-in zone of the optical disk 250. As a result, the required time for formatting the lead-in zone of the optical disk 250 is thereby saved so that the amount of time to respond a user's recording instruction is greatly improved.

After the storage data needing to be recorded is completely recorded to the data zone of the optical disk 250 or the maximum storage capacity of the optical disk 250 is reached, the optical disk drive 200 executes step 308. In step 308, if the optical disk drive 200 receives a close track/session instruction, the control circuit 220 controls the pick-up head 210 to write disk identification information into the lead-in zone of the optical disk 250. In a preferred embodiment, the pick-up head 210 directly writes the final values to each section of the lead-in zone of the optical disk 250 instead of writing initial values to the lead-in zone and then updating the data recorded in the FDCB of the lead-in zone as the prior art. In addition, the control circuit 220 further utilizes the pick-up head 210 to create a real lead-out zone or a temperately lead-out zone for the optical disk 250 to complete the recording procedure.

In a preferred embodiment of the present invention, the optical disk drive 200 further periodically records the last written address of the data zone in the memory 230 while recording the storage data into the optical disk 250 in step 306. In practice, the optical disk drive 200 can update the last written address recorded in the memory 230 per predetermined period.

Thus, even if the writing process of step 306 is abnormally interrupted by an unexpected situation, such as power discontinuity, signal source disconnected (e.g. signal terminals of TV or cable of cable TV is broken by external force), or some other situation, the optical disk drive 200 of the present invention is capable of recovering the optical disk 250 by using the last written address information recorded in the memory 230. In other words, although the storage data needing to be recorded has not been completely recorded on the optical disk 250 and the lead-in zone of the optical disk 250 has not recorded with the disk identification information, the optical disk drive 200 of the present invention can still keep most data recorded in the data zone of the optical disk 250 by selecting the last one of the last written address recorded in the memory 230 and then writing the selected last written address to the lead-in zone of the optical disk 250.

In another embodiment of the present invention, the memory 230 records the last written address of the data zone of the optical disk 250 for each predetermined period. When step 306 is finished, the memory 230 maybe recorded with a plurality of last written addresses. Next, in step 308, the optical disk drive 200 converts the plurality of last written addresses into a plurality of time values, respectively, and provides the time values to user to select a desirable data length. The optical disk drive 200 then writes the lead-in zone according to the last written address corresponding to the selected time values and creates a lead-out zone. As a result, if the user does not want to keep last parts of the storage data recorded by the optical disk drive 200 in step 306, the associated information of the last parts of the storage data are not recorded in the lead-in zone, so that the usage efficiency of the optical disk 250 is improved.

As mentioned above, the optical disk drive 200 directly writes data into the data zone of the unformatted optical disk 250 without formatting the lead-in zone first, so that the lead time of data recording is greatly reduced. In addition, the optical disk drive 200 of the present invention can record the last written address of the data zone of the optical disk 250 for each predetermined period, so that even if the recording process is unexpectedly interrupted, the optical disk drive 200 can still recover the optical disk 250 with the recorded last written address.

Those skilled in the art will readily observe that numerous modifications and alterations of the device may be made while retaining the teachings of the invention. Accordingly, the above disclosure should be construed as limited only by the metes and bounds of the appended claims.

1. A method for recording data into an unformatted optical disk, which has a lead-in zone and a data zone, the method comprising:
(a) writing a storage data into the data zone according to a predetermined laser power before the lead-in zone records data; and
(b) beginning to write disk information into the lead-in zone when the storage data is completely recorded in the data zone.

2. The method of claim 1, further comprising:
creating a lead-out zone for the optical disk when the storage data is completely recorded in the data zone.

3. The method of claim 1, further comprising:
performing an optimum power control (OPC) procedure to decide the predetermined laser power.

4. The method of claim 1, wherein the format of the optical disk is DVD+RW.

5. The method of claim 1, wherein step (a) further comprises:
recording a last written address of the data zone for each predetermined period.

6. The method of claim 5, further comprising:
if the storage data is not completely recorded in the data zone when step (a) is stopped, selecting one of the recorded last written addresses to write into the lead-in zone.

7. The method of claim 6, wherein the selected last written address is to be written into the formatting disk control blocks (FDCB) of the lead-in zone.

8. A method for recording data into an optical disk, which has a lead-in zone and a data zone, the method comprising:
(a) writing a storage data into the data zone according to a predetermined laser power;
(b) recording a last written address of the data zone per predetermined period; and
(c) if the storage data not is not completely recorded in the data zone when step (a) is stopped, selecting one of the recorded last written addresses to write into the lead-in zone.

9. The method of claim 8, wherein the selected last written address is to be written into the formatting disk control blocks (FDCB) of the lead-in zone.

10. The method of claim 8, wherein the optical disk is unformatted and step (a) is executed before any disk information is recorded into the lead-in zone.

11. The method of claim 8, further comprising beginning to write disk information into the lead-in zone when the storage data is completely recorded in the data zone.

12. The method of claim 11, further comprising creating a lead-out zone for the optical disk when the storage data is completely recorded in the data zone.

13. The method of claim 8, further comprising:
performing an optimum power control (OPC) procedure to decide the predetermined laser power.

14. The method of claim 8, wherein the format of the optical disk is DVD+RW.

15. An optical storage device for recording a storage data into an optical disk, which has a lead-in zone and a data zone, the optical storage device comprising:
a pick-up head writing the storage data into the optical disk; and
a control circuit electrically connected to the pick-up head for controlling the pick-up head to write the storage data into the data zone according to a predetermined laser power before the lead-in zone being recorded with data and for controlling the pick-up head to begin to write disk information into the lead-in zone when the storage data being completely recorded in the data zone.

16. The optical storage device of claim 15, wherein the optical disk is an unformatted DVD.

17. The optical storage device of claim 15, wherein the optical disk is an unformatted DVD+RW disk.

18. The optical storage device of claim 15, further comprising:
a memory electrically connected to the control circuit for recording a last written address of the data zone for each predetermined period.

19. The optical storage device of claim 18, wherein if the storage data is not completely recorded in the data zone when the pick-up head stops writing, the control circuit controls the pick-up head to write one of the last written addresses recorded in the memory into the lead-in zone.

20. The optical storage device of claim 18, wherein the memory is a non-volatile memory.
